(19) United States
(12) Patent Application Publication
(10) Pub. No.: US 2001/0018105 A1
(43) Pub. Date: Aug. 30, 2001

(54) Multilayer plastic pipe with good layer adhesion

(75) Inventors: Guido Schmitz, Duelmen (DE); Georg Oenbrink, Duelmen (DE); Walter Hellermann, Dorsten (DE); Thomas Grosse-Puppendahl, Haltern (DE); Harald Haeger, Marl (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA-HUELS AKTIENGESELLSCHAFT, Frankfurt (DE)

(21) Appl. No.: 09/753,613

(22) Filed: Jan. 4, 2001

(30) Foreign Application Priority Data
Jan. 21, 2000 (DE) 10002461.0

(51) Int. Cl. B32B 1/08

(52) U.S. Cl. 428/36.91

(57) ABSTRACT

A multilayer plastic pipe having strong bonding between the layers has at least one layer I of a polyolefin molding composition comprising a polyolefin, at least one layer II of a polyester molding composition, and at least one layer III of an adhesion promoter containing reactive groups and located between layers I and II. The polyester molding composition of layer II comprises a polyester and one or more compounds selected from a compound having two or more carbodiimide groups, carboxylic anhydride groups, maleimide groups or oxazine groups.

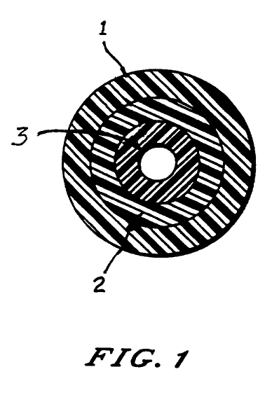

### BACKGROUND OF THE INVENTION

1. Field of the Invention

The invention relates to a multilayer plastic pipe having a polyolefin layer and a barrier layer of a thermoplastic polyester, and at least one intervening adhesion promoting layer containing reactive groups.

2. Discussion of the Background

Plastic pipes made from polyolefins, in particular from polyethylene and polypropylene, are known and are employed for many applications. Such plastic pipes must, inter alia, be inert toward the medium flowing in them and resistant to high and low temperatures and to mechanical load.

Single-layer pipes made from polyolefins are unsuitable for a number of applications. For example, because of increasing environmental concerns and the corresponding tightening of legal requirements, single-layer polyolefin pipes previously employed for transporting fuels in underground gas station supply lines, must be replaced by pipes having improved barrier properties to prevent diffusion of the fuel, or components of the fuel, through the pipe and into the ground.

Moreover, such pipes should not only exhibit an excellent barrier to the diffusion of chemical agents transported in the interior of the pipe, but also to chemical agents, solvents, aqueous salt solutions and the like which can penetrate through the pipe wall from the outside into the liquids transported in the pipe. This applies, for example, to drinking-water lines laid in contaminated or polluted soil.

EP-A-0 686 797 discloses multilayer plastic pipes which comprise the following layers:

at least one layer based on a polyolefin,

at least one layer based on a thermoplastic polyester, bonded via

an intermediate layer of a suitable adhesion promoter containing reactive groups,

where adjacent layers are cohesively bonded to one another, and the polyester may be modified by addition of a compound containing two or more epoxide groups, a compound containing two or more oxazoline groups or a compound containing two or more isocyanate groups. However, this modified polyester has a very narrow processing window, because it is difficult to control the molecular weight of the polyester, which tends to increase due to chain extension, and thereby greatly increase the melt viscosity of the polyester. Moreover, if one tries to improve the processing properties of the such modified polyesters by increasing the processing temperature, the polyester tends to thermally degrade. In addition, it has been found that the layer adhesion is still inadequate in some cases.

Furthermore, the modifiers disclosed in EP-A-0 686 797 are relatively volatile. Because of the high reactivity and toxicity of the modifiers, in particular of the isocyanate modifiers, the polyester molding composition modified therewith can only be safely processed by enclosing the compounder used to manufacture the pipe. Such enclosures are expensive, and make the manufacturing process more difficult. Furthermore, the potential risk to machine operators is still considerable during subsequent processing.

### SUMMARY OF THE INVENTION

The object of the present invention is therefore to produce polyolefin pipes having a polyester barrier layer in which strong adhesion between layers is present, by modifying the polyester so that the molding compositions can be produced and further processed with conventional safety devices, such as, for example, spot extraction.

This object has been achieved by a multilayer plastic pipe which comprises the following layers:

I) at least one layer of a polyolefin molding composition,

II) at least one layer of a polyester molding composition which comprises one or more compounds selected from

a) a compound having two or more carbodiimide groups,

b) a compound having two or more carboxylic anhydride groups,

c) a compound having two or more maleimide groups,

d) a compound having two or more oxazine groups, and

III) at least one layer of an adhesion promoter containing reactive groups, which is located between layer I and layer II.

The polyester molding composition preferably comprises from 0.1 to 15% by weight of the compounds a) to d), preferably from 0.25 to 10% by weight and particularly preferably from 0.5 to 5% by weight.

Layer I consists of a molding composition based on polyolefins. Suitable polyolefins are homopolymers and copolymers based, inter alia, on ethylene, propylene, 1-butene, 1-hexene and 1-octene. Also suitable are copolymers and terpolymers which, in addition to the above-mentioned monomers, also comprise further monomers, in particular dienes, such as, for example, ethylidenenorbomene, cyclopentadiene or butadiene. Molding compositions based on polypropylene or polyethylene are preferred.

The molding composition for layer I may be crosslinked by known methods in order to improve the mechanical properties, for example the low-temperature impact strength and the heat deflection temperature. The crosslinking is carried out, for example, by radiation crosslinking or by moisture crosslinking silane-containing polyolefin molding compositions.

The thermoplastic polyester of layer II has the following basic structure:

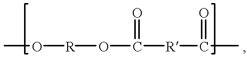

where R is a divalent branched or unbranched aliphatic and/or cycloaliphatic radical having 2 to 12, preferably 2 to 8, carbon atoms in the carbon chain, and R′ is a divalent aromatic radical having 6 to 20, preferably 8 to 12 carbon atoms in the carbon skeleton.

Diols which may be employed in preparing the polyester include, for example, ethylene glycol, trimethylene glycol, tetramethylene glycol, hexamethylene glycol, neopentyl glycol, cyclohexanedimethanol, and the like.

Up to 25 mol % of said diol may be replaced by a diol having the following general formula:

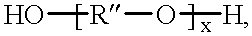

where R″ is a divalent radical having 2 to 4 carbon atoms, and x can adopt a value of from 2 to 50.

The preferred diols are ethylene glycol and tetramethylene glycol.

Examples of aromatic dicarboxylic acids which may be employed in preparing the polyester are terephthalic acid, isophthalic acid, 1,4-, 1,5-, 2,6- and 2,7-naphthalenedicarboxylic acid, diphenic acid, 4,4′-oxybis(benzoic acid) or polyester-forming derivatives thereof, such as, for example, dimethyl esters.

Up to 20 mol % of these dicarboxylic acids may be replaced by aliphatic dicarboxylic acids, such as, for example, succinic acid, maleic acid, fumaric acid, sebacic acid, dodecanedioic acid, inter alia.

These thermoplastic polyesters may be prepared by known methods, for example as described in DE-A 24 07 155, 24 07 156, Ullmanns Encyclopadie der technischen Chemie (Ullmann's Encyclopedia of Industrial Chemistry), 4th Edition, Volume 19, pages 65 ff., Verlag Chemie GmbH, Weinheim, 1980, incorporated herein by reference.

The polyesters employed in accordance with the present invention have a viscosity index (J value) in the range from 80 to 240 cm³/g.

Preferred thermoplastic polyesters are polyethylene terephthalate, polypropylene terephthalate, polybutylene terephthalate, polyethylene naphthalate, polypropylene naphthalate and polybutylene naphthalate.

If necessary, the polyesters can be impact-modified in a conventional manner. For example, from 0.5 to 40% by weight, preferably from 5 to 35% by weight, of a known impact modifier can be added. This is generally a rubber, which may, if desired, be functionalized, or a polyester-polyalkylene glycol block copolymer.

Conventional auxiliaries and additives, such as, for example, flameproofing agents, stabilizers, plasticizers, processing aids, viscosity improvers, fillers, in particular those for improving the conductivity, pigments or the like, can be added to the molding compositions or layers I or II.

The compound containing two or more carbodiimide groups can be, for example, a compound of the following type:

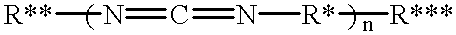

where n is at least 2, R* is an aliphatic, cycloaliphatic, aromatic or araliphatic radical having 2 to 22 carbon atoms, and R** and R*** are any desired groups used in the preparation of the carbodiimide-containing compound to limit the molecular weight thereof.

Examples of suitable compounds containing two or more carboxylic anhydride groups are butane-1,2,3,4-tetracarboxylic dianhydride, pyromellitic dianhydride, esters made from diols and trimellitic anhydride, products of the addition reaction of polybutadiene oil and maleic anhydride or perylene-3,4,9,10-tetracarboxylic dianhydride.

Examples of suitable compounds containing two or more maleimide groups are the following compounds: 1,3-phenylenebismaleimide, 1,4-phenylenebismaleimide, 3-methyl-1,4-phenylenebismaleimide, 5-methyl-1,3-phenylenebismaleimide, 4,4′-(N,N′-bismaleimido)diphenylmethane, 2,4-bismaleimidotoluene, 3,3′-(N, N′-bismaleimido)diphenylmethane, 3,3′-(N,N′-bismaleimido)diphenyl sulfone, 4,4′-(N,N′-bismaleimido)diphenyl sulfone, 1,2-ethylenebismaleimide, 1,3-propylenebismaleimide, 1,4-butylenebismaleimide, 1,10-decenebismaleimide, 1,12-dodecenebismaleimide and 1,3-bis(citraconimidomethyl)benzene. The maleimide groups can optionally be substituted at the double bond by one or two alkyl groups, each having 1 to 4 carbon atoms.

Examples of suitable compounds containing two or more oxazine groups are the compounds of the following type:

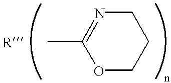

where n is at least 2, and R′″ can be an aliphatic, cycloaliphatic, aromatic or araliphatic radical having 2 to 22 carbon atoms.

Suitable adhesion promoters in layer III are molding compositions which form a strong bond with the adjacent layers I and II upon production of the multilayer pipes by coextrusion, so that the layers cannot easily be separated from one another in the finished pipe by mechanical means.

Suitable molding compositions for the adhesion promoters of layer III consist of a polymer base, in particular of polyolefins, which has been modified by means of suitable reactive groups. The reactive groups here can be introduced either by copolymerization or by a grafting reaction. In the grafting reaction, a pre-formed polyolefin is, for example, reacted in a known manner with, for example, an unsaturated, functional monomer and a free-radical donor, at elevated temperature.

Examples of suitable reactive groups are acid anhydride groups, N-acyllactam groups, carboxyl groups, epoxide groups, oxazoline groups, trialkoxysilane groups and hydroxyl groups.

The choice of a suitable polymer base for the adhesion promoter depends on the composition of layer I. The polymer base for the adhesion promoter should be selected so that the adhesion promoter is as compatible as possible, preferably miscible, with the polyolefinic layer I. If the layer I consists of a molding composition based on polypropylene, polypropylene is also suitable as the base for the adhesion promoter.

Preferably, layer I consists of a molding composition based on polyethylene. In this case, ethylene-methyl methacrylate-maleic anhydride copolymers and particularly preferably ethylene-vinyl acetate-maleic anhydride copolymers, inter alia, have proven to be particularly suitable adhesion promoters.

Suitable functionalized polyethylenes and polypropylenes are obtainable, inter alla, under the trade names BYNEL (DuPont), PRIMACOR (Dow), POLYBOND (BP), OREVAC (Elf), HERCOPRIME (Hercules), EPOLENE (Eastman), HOSTAMONT. EXXELOR (Exxon) and ADMER (Mitsui Petrochemical)

The multilayer pipes according to the invention can contain more than one of the layers I, II and III. In this case, the layers should be arranged in such a way that the layers I and II are always bonded to one another via an intermediate layer III.

Examples of possible layer arrangements are shown in the following table.

Table 1: Layer arrangement of multilayer plastic pipes according to the invention (structure from the outside inward)

| Layer arrangement No. | Layer Structure |
|---|---|
| 1 | Layer I |
| | Layer III |
| | Layer II |
| 2 | Layer II |
| | Layer III |
| | Layer I |
| 3 | Layer I |
| | Layer III |
| | Layer II |
| | Layer III |
| | Layer I |
| 4 | Layer II |
| | Layer III |
| | Layer I |
| | Layer III |
| | Layer II |

Multilayer pipes in which the thickness of layer II makes up from 1 to 50%, preferably from 5 to 20%, of the total wall thickness are preferred.

The thickness of layer III is preferably from 0.05 to 20%, particularly preferably from 0.4 to 4%, of the total wall thickness. The total wall thickness here is the sum of the individual layers and is equal to the wall thickness of the pipe

The multilayer pipes are preferably produced by coextrusion, but other production processes, such as extrusion coating or injection molding, are also possible. The pipes can be fully or partly corrugated.

The multilayer pipes according to the invention have outstandingly good resistance and barrier properties to diffusion of chemical agents, solvents and fuels, particularly methanol-containing fuels. Furthermore, the layers are cohesively bonded to one another, and consequently the various layers do not shear off from one another, for example, due to thermal expansion, flexing or thermoforming of the multilayer pipe. This good layer adhesion is also retained on extended contact with fuels, in particular methanol-containing fuels.

The plastic pipes according to the invention are preferably employed for the transport of chemicals, in particular petrochemical substances, and for holding or transporting brake, cooling and hydraulic fluids and fuel, in particular methanol-containing and ethanol-containing fuels.

The pipes are particularly suitable for above ground and underground applications, for example in gas stations and similar areas, in order to transport chemicals, particularly petrochemicals, more particularly fuel, through them.

The pipes are also suitable for use in motor vehicles for holding fuels, in particular methanol-containing fuels.

The pipes are furthermore also suitable for use in drinking-water lines laid in polluted soil.

A further use of the multilayer pipes according to the invention consists in the production of hollow articles, such as fuel tanks or filler necks, in particular for motor vehicles, for example by blow molding.

When the multilayer pipe according to the present invention is used for the transport or storage of flammable liquids, gases or dusts, such as, for example, fuel or fuel vapors, it is advisable to provide one of the layers of the composite, or alternatively an additional inner layer, with an electrically conductive finish. This can be accomplished by compounding the molding composition of any of the layers with any of the conventional electrically conductive additives known. Examples of conductive additives are conductive carbon black, metal flakes, metal powder, metallized glass beads, metallized glass fibers, metal fibers (for example made from stainless steel), metallized whiskers, carbon fibers (including metallized), intrinsically conductive polymers or graphite fibrils. It is also possible to employ mixtures of different conductive additives.

In the preferred case, the electrically conductive layer is in direct contact with the medium to be transported or stored and has a maximum surface resistance of 10⁹ Ωcm.

In one embodiment, the multilayer pipe according to the invention can be sheathed with an additional elastomer layer. Both crosslinking rubber compositions and thermoplastic elastomers are suitable for the sheathing. The sheathing can be applied to the pipe, either with or without use of an additional adhesion promoter, for example by means of extrusion via a crosshead die or by pushing a prefabricated elastomer tube over the ready-extruded multilayer pipe.

Having generally described this invention, a further understanding can be obtained by reference to certain specific examples which are provided herein for purposes of illustration only, and are not intended to be limiting unless otherwise specified.

In the experiments, the following components were used:

Polyolefin of Layer I:

PO 1: STAMYLAN HD 9630, a high-density polyethylene (HDPE) from DSM Polyethylenes BV

Polyester of Layer II:

PES 1: Mixture of

a) 98% by weight of polybutylene terephthalate (VESTODUR 2000 from DEGUSSA-HÜLS AG) and

b) 2% by weight of PERKALINK 900 [1,3-bis-(citraconimidomethyl)benzene].

PES 2: Mixture of

a) 98% by weight of polybutylene terephthalate (VESTODUR 2000 from DEGUSSA-HÜLS AG) and

b) 2% by weight of a mixture consisting of

b1) 50% by weight of PERKALINK 900 [1,3-bis-(citraconimidomethyl)benzene]and

b2) 50% by weight of HVA 2 (N,N′-m-phenylenedimaleimide).

PES 3: (not according to the invention): polybutylene terephthalate (VESTODUR 2000 from DEGUSSA-HÜLS AG)

Adhesion Promoter of Layer III:

AP 1: Molding composition based on polyethylene (LDPE), modified with maleic anhydride so that the molding composition contains 0.4% by weight of anhydride groups.

AP 2: Molding composition based on ethylene-vinyl acetate copolymer, modified with maleic anhydride so that the molding composition contains 0.1% by weight of anhydride groups.

AP 3: Molding composition based on ethylene-acrylate copolymer, modified with maleic anhydride so that the molding composition contains 0.1% by weight of anhydride groups.

In order to test the layer adhesion, a three-layer ribbon coextrusion was carried out. A ribbon coextrusion mold having an outlet width of 30 mm was used for this purpose, with the various melts being brought together in the mold just before exit of the melt from the mold. The mold was fed by three Storck 25 extruders. After exiting from the mold, the three-layer composite was laid onto a chill roll and taken off (chill-roll method). The adhesion results from the three-layer ribbon coextrusion are shown in Table 1.

The adhesion scores shown therein have the following meanings:

0 no adhesion

1 slight adhesion

2 some adhesion; can be separated with little effort

3 good adhesion; can only be separated with great effort and possibly with the aid of tools

4 inseparable adhesion

TABLE 1

| | | | | Adhesion | |
|---|---|---|---|---|---|
| | | Adhesion | | Layer I/ | Layer III/ |
| | | promoter | | layer III | layer II |
| Example | Layer I | (layer III) | Layer II | interface | interface |
| 1 | PO1 | AP 1 | PES 1 | 4 | 3 |
| 2 | PO1 | AP 1 | PES 2 | 4 | 3 |
| 3*) | PO1 | AP 1 | PES 3 | 4 | 0 |
| 4 | PO1 | AP 2 | PES 1 | 4 | 4 |
| 5 | PO1 | AP 2 | PES 2 | 4 | 4 |
| 6*) | PO1 | AP 2 | PES 3 | 4 | 0 |
| 7 | PO1 | AP 3 | PES 1 | 4 | 4 |
| 8 | PO1 | AP 3 | PES 2 | 4 | 4 |
| 9*) | PO1 | AP 3 | PES 3 | 4 | 0 |

*)not according to the invention

The results obtained in these preliminary experiments were subsequently checked by extrusion of corresponding three-layer pipes, where these results were confirmed.

Obviously, numerous modifications and variations of the present invention are possible in light of the above teachings. It is therefore to be understood that within the scope of the appended claims, the invention may be practiced otherwise than as specifically described herein.

The priority document of the present application, German patent application 10002461.0 filed Jan. 21, 2000, is incorporated herein by reference.

What is claimed as new and is intended to be secured by Letters Patent is:

1. A multilayer plastic pipe which comprises the following layers:
I) at least one layer I of a polyolefin molding composition comprising a polyolefin,
II) at least one layer II of a polyester molding composition, and
III) at least one layer III of an adhesion promoter containing reactive groups which is located between I and II,
wherein the polyester molding composition of layer II comprises a polyester and one or more compounds selected from
a) a compound having two or more carbodiimide groups,
b) a compound having two or more carboxylic anhydride groups,
c) a compound having two or more maleimide groups,
d) a compound having two or more oxazine groups.

2. The multilayer plastic pipe of claim 1, wherein the polyester of layer II is at least one polymer selected from the group consisting of polyethylene terephthalate, polypropylene terephthalate, polybutylene terephthalate, polyethylene naphthalate, polypropylene naphthalate and polybutylene naphthalate.

3. The multilayer plastic pipe of claim 1, wherein the polyolefin of layer I is at least one polymer selected from the group consisting of polyethylene and polypropylene.

4. The multilayer plastic pipe of claim 1, which is fully or partly corrugated.

5. The multilayer plastic pipe of claim 2, which is fully or partly corrugated.

6. The multilayer plastic pipe of claim 3, which is fully or partly corrugated.

7. The multilayer plastic pipe of claim 1, wherein one of said layers I to III further comprises an electrically conductive finish.

8. The multilayer plastic pipe of claim 2, wherein one of said layers I to III further comprises an electrically conductive finish.

9. The multilayer plastic pipe of claim 3, wherein one of said layers I to III further comprises an electrically conductive finish.

10. The multilayer plastic pipe of claim 1, further comprising an additional inner layer having an electrically conductive finish.

11. The multilayer plastic pipe of claim 2, further comprising an additional inner layer having an electrically conductive finish.

12. The multilayer plastic pipe of claim 3, further comprising an additional inner layer having an electrically conductive finish.

13. The multilayer plastic pipe of claim 1, produced by coextrusion, extrusion coating or injection molding.

14. The multilayer plastic pipe of claim 2, produced by coextrusion, extrusion coating or injection molding.

15. The multilayer plastic pipe of claim 3, produced by coextrusion, extrusion coating or injection molding.

16. A hollow article manufactured from the multilayer plastic pipe of claim 1.

17. A hollow article manufactured from the multilayer plastic pipe of claim 2.

18. A hollow article manufactured from the multilayer plastic pipe of claim 3.

19. The hollow article of claim 16, wherein said hollow article is selected from the group consisting of a fuel tank and a fuel tank filler neck.

20. The hollow article of claim 17, wherein said hollow article is selected from the group consisting of a fuel tank and a fuel tank filler neck.

21. The hollow article of claim 18, wherein said hollow article is selected from the group consisting of a fuel tank and a fuel tank filler neck.

22. The hollow article of claim 16, produced by blow molding.

23. The hollow article of claim 17, produced by blow molding.

24. The hollow article of claim 18, produced by blow molding.

25. The multilayer plastic pipe of claim 1, wherein said multilayer plastic pipe is selected from the group consisting of a fuel line, a fuel vapor line, a brake line, a coolant line, a hydraulic fluid line, a pipe for transporting fuel in a gas station, and a drinking water line.

26. The multilayer plastic pipe of claim 2, wherein said multilayer plastic pipe is selected from the group consisting of a fuel line, a fuel vapor line, a brake line, a coolant line, a hydraulic fluid line, a pipe for transporting fuel in a gas station, and a drinking water line.

27. The multilayer plastic pipe of claim 3, wherein said multilayer plastic pipe is selected from the group consisting of a fuel line, a fuel vapor line, a brake line, a coolant line, a hydraulic fluid line, a pipe for transporting fuel in a gas station, and a drinking water line.
